(19) United States
(12) Patent Application Publication
(10) Pub. No.: US 2003/0131247 A1
(43) Pub. Date: Jul. 10, 2003

(54) System and method that provides access control to entertainment media using a personal identification device

(75) Inventor: Gregory L. Cannon, Boynton Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/284,410

(22) Filed: Oct. 31, 2002

Related U.S. Application Data
(60) Provisional application No. 60/330,794, filed on Oct. 31, 2001.

(51) Int. Cl. H04L 9/00

(52) U.S. Cl. 713/186

(57) ABSTRACT

An identification device, which can be a wireless transceiver biometric device, can be used to control access to copyrighted (e.g., entertainment) media. This is done by establishing rights to use of the media correlated to a purchaser of the media based on verifying the identity of the purchaser with the identification device. Once verified, the media can be purchased and rights correlating the purchased media to the purchaser can be stored. When a requester attempts to output the purchased media, the identity of the requestor and their rights to the purchased media can be verified through the use of the identification device. Once verified, the media can be output. Therefore, by using the identification device, a cost effective method and system can be established to control access to copyrighted media.

### RELATED APPLICATIONS

This application claims priority under 35 U.S.C. §119(e) to U.S. Prov. App. No. 60/330,794, filed Oct. 31, 2001, which is incorporated herein by reference in its entirety.

### FIELD OF THE INVENTION

The present invention relates generally to a piezoelectric identification device and applications thereof. More particularly, it relates to a device for obtaining biometric information, such as a print, and using the obtained information to recognize and/or identify an individual.

### BACKGROUND OF THE INVENTION

Biometrics are a group of technologies that provide a high level of security. Print capture and recognition is an important biometric technology. Law enforcement, banking, voting, and other industries increasingly rely upon prints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

Optical print scanners are available which detect a reflected optical image of a print. To capture a quality image at a sufficiently high resolution, optical print scanners require at minimum optical components (e.g., lenses), an illumination source, and an imaging camera. Such components add to the overall cost of a print scanner. Mechanical structures to maintain alignment also increase manufacturing and maintenance costs.

Solid-state silicon-based transducers are also available in print scanners sold commercially. Such silicon transducers measure capacitance. This requires the brittle silicon transducers to be within a few microns of the print sensing circuit reducing their durability. To detect a rolled print, the sensing array of the solid-state transducer needs to have an area of 1 inch×1 inch and a thickness of about 50 microns. This is a big geometry for silicon that increases the base cost of a print scanner and leads to greater maintenance costs. Durability and structural integrity are also more likely to suffer in such a large silicon geometry. This makes solid-state, silicon-based transceivers impractical for ubiquitous use in many commercial and consumer applications.

Copyrighted media, specifically digital copyrighted media, can include many different forms of media, including music, movies, books, magazines, displays, recordings, etc. Also, the copyrighted media can be stored in various devices, such as digital video discs, compact discs, magnetic tape, radon access memory, other computer based memory stored either locally or remotely accessed via a network, etc. Thus, the stored copyrighted media can be output through various devices, such as computers, juke boxes, display screens, radios, televisions, etc.

Accessing various forms of copyrighted media has some safeguards, but security for the copyrighted media has not kept up with technology used to steal. Therefore, copyrighted materials are being illegally copied, distributed, or otherwise displayed without compensating the copyright owner for using the materials. Systems have been designed to limit access to the copyrighted media based on passwords, codes, identification cards, etc., but these authentication devices can be stolen and/or counterfeited. These systems based on passwords, codes, identification cards, etc. are expensive to implement, cumbersome to maintain, and require some sort of human support (e.g., a telephone operator to verify code, or the like). Also, there is weak licensee integrity because any number of people may be able to get access to a password or a code.

What is needed is an inexpensive, durable print scanner with low maintenance costs. What is also needed is system and method using the print scanner that can be used to control access to copyrighted media, which is not easily stolen or counterfeited.

### BRIEF SUMMARY OF THE INVENTION

Embodiments of the present invention provide a method including the steps of establishing identity in a media purchasing control system using a biometric device (e.g., a wireless transceiver biometric device) to purchase media. The method also includes the step of correlating the identity to the purchased media and storing rights relating to the correlation. The method also includes the step of receiving the purchased media in a secure output device. The method also includes the steps of establishing the identity in the secure output device using the biometric device and determining if the identity matches the stored rights. If the identity matches the stored rights, the method also includes the step of allowing the output of the purchased media from the secure output device.

Other embodiments of the present invention provide a system including media to be purchased, a purchasing controller coupled to the media, and a biometric device (e.g., wireless transceiver) coupled to the purchasing controller.

Still further embodiments of the present invention provide a system including a secured output device that outputs purchased media, a rights checking device coupled to the secured output device, and a biometric device (e.g., wireless transceiver) coupled to the secured output device that sends biometric information to the rights checking device via the secure output device to verify access rights to the secured device to access the copyrighted media.

Systems and methods of the present invention can provide several advantages, such as: biometric level security, the are easily used with ubiquitous handheld wireless devices, they are relatively inexpensive to implement and operate, and they have high licensee integrity (e.g., only licensee can operate them).

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 illustrates system using a wireless transceiver biometric device to control access to entertainment media according to embodiments of the present invention.

FIG. 8A is a flow chart depicting a method for establishing entertainment rights according to embodiments of the present invention.

FIG. 8B is a flow chart depicting a method for using established entertainment rights to perform accessing of entertainment media according to embodiments of the present invention.

FIG. 9A is a flow chart depicting a method for storing established entertainment rights according to embodiments of the present invention.

FIG. 9B is a flow chart depicting a method for storing established entertainment rights according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

The piezoelectric identification device, which can be a wireless device, can be used to control access to copyrighted (e.g., entertainment) media. This is done by establishing rights to use of the media correlated to a purchaser of the media based on verifying the identity of the purchaser with the piezoelectric identification device. Once verified, the media can be purchased and rights correlating the purchased media to the purchaser can be stored. When a requester attempts to output the purchased media, the identity of the requester and their rights to the purchased media can be verified through the use of the piezoelectric identification device. Once verified, the media can be output. Therefore, by using the piezoelectric identification device, a cost effective method and system can be established to control access to copyrighted media.

The present invention relates generally to an identification device and applications thereof. More particularly, it relates to a device for obtaining biometric data or information, such as for a print, and using the obtained information to recognize and/or verify the identify of an individual. Print can be any type of print including, but not limited to, a print of all or part of one or more fingers, palms, toes, foot, hand, etc. A print can also be a rolled print, a flat print, or a slap print. The use of the term “data” or “information” throughout the specification can be representative of a biometric, a digital or other image of a biometric (e.g., a bitmap or other file), extracted digital or other information relating to the biometric, etc.

The use of the term “match” or “matching” can be defined as a one-to-one process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as the process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee who template was matched.

II. Wireless Transceiver Biometric Devices

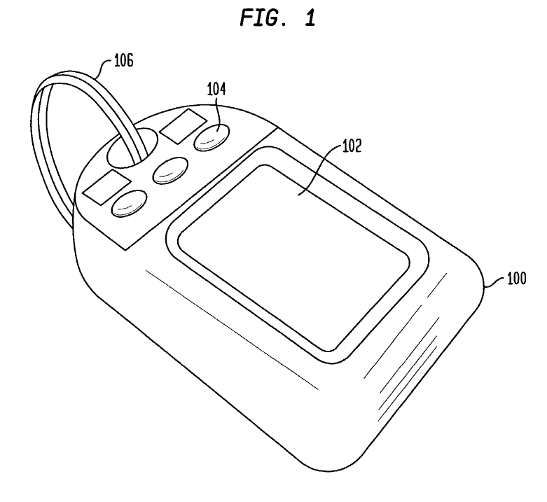

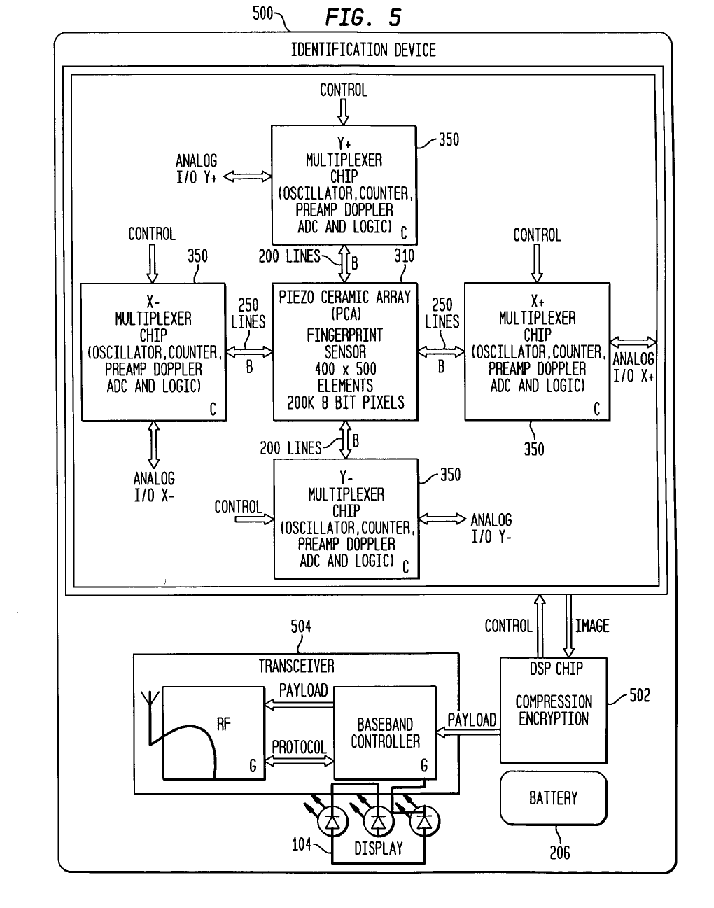

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

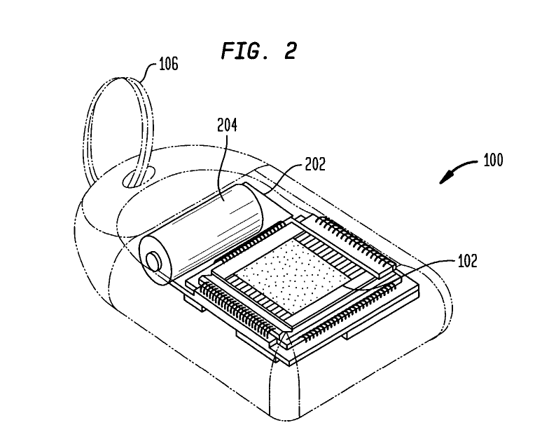

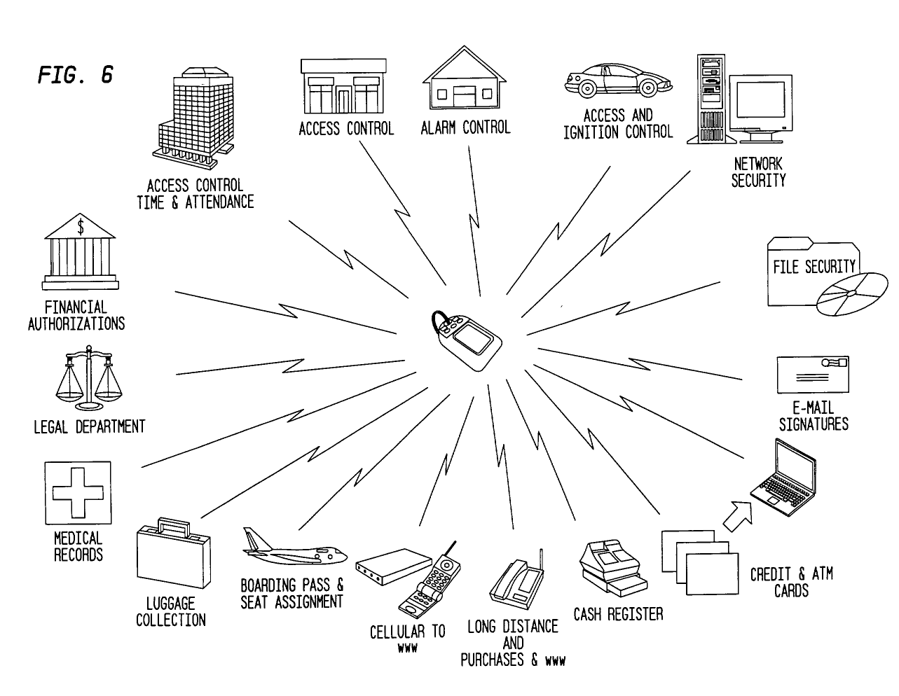

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-9B.

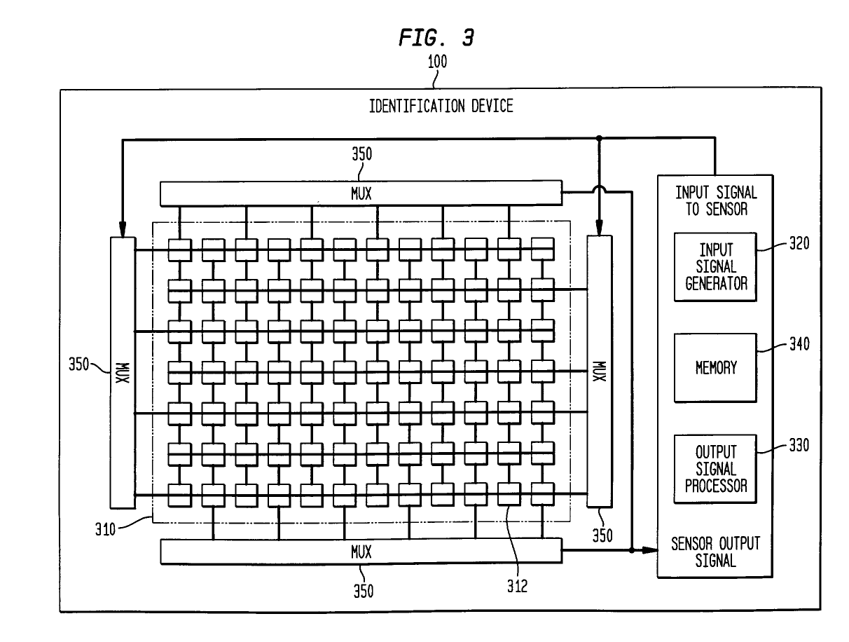

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the Prov. App No. 60/330,794, which is incorporated by reference herein in its entirety.

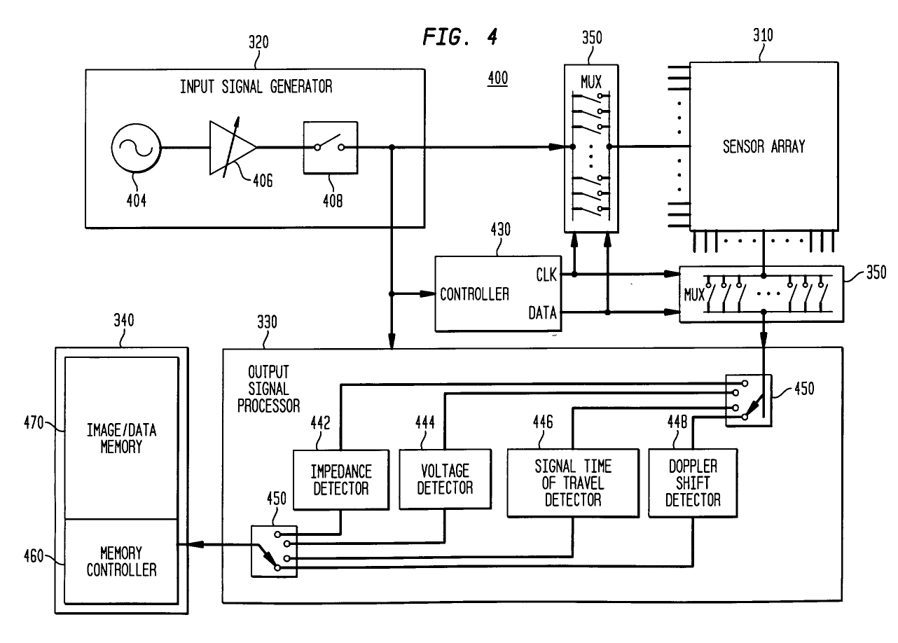

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. No. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400, and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Entertainment Rights Verification Applications

In some embodiments, wireless transceiver biometric device 100 can be used to verify customer rights to copyrighted media (e.g., music and movies). The medium (e.g., machine or device) used to play the copyrighted material can be equipped to interface with wireless transceiver biometric device 100 and determine what particular rights (e.g., play once, play multiple times, copy privileges, etc.) the user has with regards to a particular media. In some embodiments, wireless transceiver biometric device 100 can also be used to effect reimbursement of royalties and fees related to copyrighted media access. Media rights reimbursement and enforcement is provided via the wireless transceiver biometric device 100 using a print ID and universally unique identification (UUID).

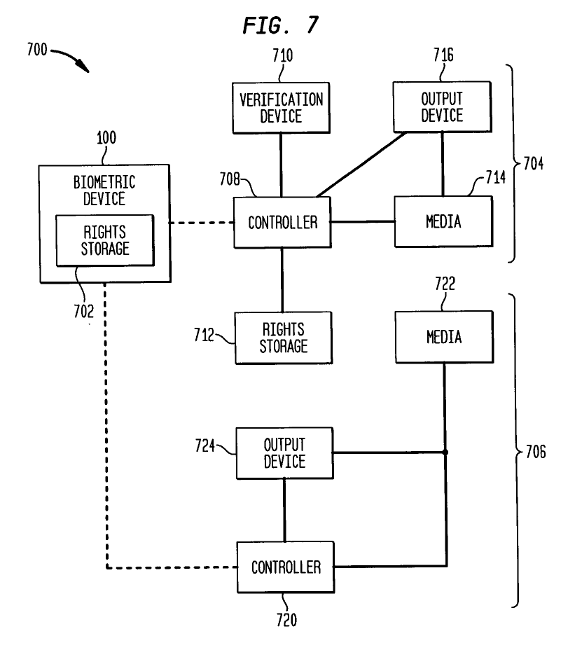

FIG. 7 shows a system 700 that controls access to entertainment media according to embodiments of the present invention. In some embodiments, wireless transceiver biometric device 100 (although 100 is used, device 400 or 500 could also be used) has a storage device 702 (e.g., a database that list rights, for example customer name, purchase date, item purchased, licence type, etc., a database that includes a digital purchase receipt, etc.) for rights (e.g., rights a licensee has to copyrighted media). System 700 includes two subsystems 704 and 706. In various embodiments, these subsystems 704 and 706 can be at a same location or at different locations. Also, although only one of each subsystem 704 and 706 is shown, there can be more than one at each location.

With continuing reference to FIG. 7, subsystem 704 is utilized when wireless transceiver biometric device 100 does not have rights storage 702. Subsystem 704 includes a controller 708 coupled to a verification device 710, storage device for rights 712, a media product (e.g., media) 714 (e.g., movies, music, or other copyrighted products), and an output device 716. Media 714 can be any form of copyrighted works that a copyright owner has determined to require restricted access, such that only legitimate licensees have access under various Copyright Laws. Some examples of media 714 can be movies, music, magazines, books, etc. that are stored on digital video discs, magnetic medium, optical medium, compact discs, a computer or server storage device(s) (e.g., either locally or remotely via a wired or wireless network), or the like. Media 714 is typically licensed for one, a plurality, or unlimited use by one or more people at a same or different time. Thus, accurate access control is important. Rights storage 712 can be either maintained at and by the supplier of the media or maintained at a remote location either by the supplier of the media or one or more third parties. Media 714 is also coupled to output device 716 (e.g., a device that allows a legitimate licensee to partake of media 714, for example an audio or video system).

Subsystem 706 is utilized when wireless transceiver biometric device 100 has rights storage 702. Subsystem 706 includes a controller 720 coupled to a media 722 (similar to media 714), and an output device 724 (similar to output device 716). Media 722 is also coupled to output device 724.

Through an operation of system 700 described below, media 714 or 722 is protected by an extra layer of security based on using biometric device 100. This is because media 714 or 722 cannot be output without an individual first establishing rights to media 714 or 722 via biometric device 100. Thus, because biometrics are unique to the individual and cannot be easily counterfeited, accurate access control is achieved for the media 714 and 722. By having this access control, copyright owners receive more income because only legitimate licensees are using their works. Also, consumer's may find costs for the copyrighted works have been reduced because copyright owners do not have to compensate for rampant copyright infringement activities around the world.

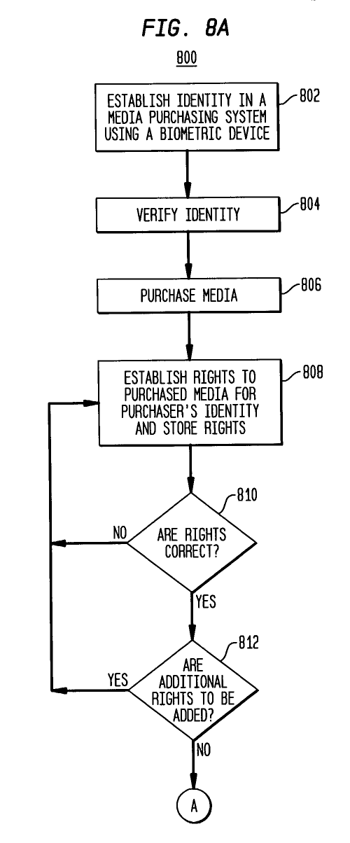

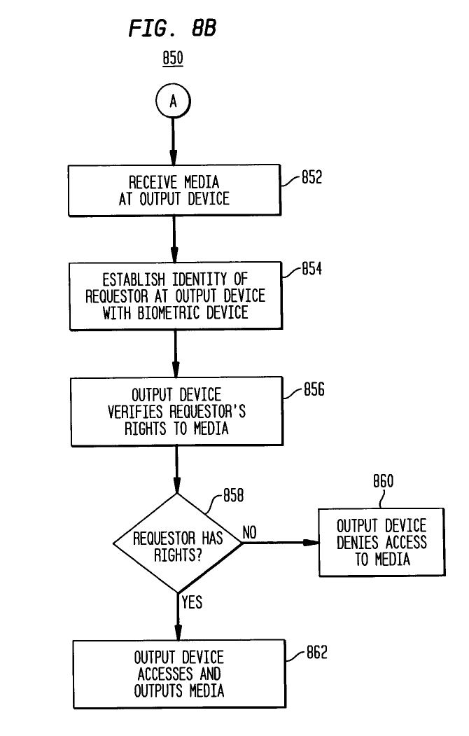

FIG. 8A is a flow chart depicting a method 800 for establishing and storing entertainment rights according to embodiments of the present invention. At step 802, an identity information of a purchaser is established in a media purchasing system (e.g., system 700) using a biometric device (e.g., wireless transceiver biometric device 100, 400, or 500). At step 804, the purchaser's identity is verified (e.g., with verification device 710). For example, verification can be done by a third party. In some embodiments, the purchaser submits his/her UUID and a print via the biometric device and a third party verification service verifies the identity of the purchaser.

After the purchaser's identity is verified, at step 806 media (e.g., media 714 or 722) is purchased. At step 808, rights (e.g., entertainment rights) are established for the purchased media for the purchaser's identity and those rights are stored (e.g., in rights storage 702 or 712). At step 810, a determination is made (e.g., the rights are tested against predetermined criteria) whether the rights are correct. If no, step 808 is repeated. If yes, at step 812 a determination is made whether additional rights are to be added. If yes, the steps 808 and 810 are repeated. If no, then the system moves on to method 850 (FIG. 8B).

FIG. 8B is a flow chart depicting method 850 that uses stored rights correlated to a requestor's identity to allow access and output of purchased media according to embodiments of the present invention. At step 852, media (e.g., media 714 or 722) is “received” at an output device (e.g., output device 716 or 724). In various embodiments, to be “received” can mean physically, electronically, digitally, or any other way the media can be input to the output device, which can be under control of a controller (e.g., controller 708 or 720), so that it can be “played” through the output device. At step 854, a biometric device (e.g., device 100, 400, or 500) is used to establish the requestor's identity at the output device. At step 856, the output device verifies (e.g., possible using verification device 710 or controller 820) that the requester has rights to the media. At step 858, a determination is made whether the verification was successful, i.e., that the requestor has rights to the media. If no, at step 860 the output device denies the requester access to the media. If yes, at step 862, the output device accesses and outputs the media to the requestor.

Thus, in contrast to conventional identity checking systems that rely on easily counterfeited identification cards, through the use of a wireless transceiver biometric device 100, 400, and/or 500 at step 854 biometric based access control is utilized. This substantially reduces, if not eliminates, any non-legitimate licensees from accessing protected copyrighted works. Hence, copyright owners can have more confidence that they are receiving proper compensation for their intellectual property and consumer's can benefit from reduced costs brought about by the reduction or elimination in copyright infringement.

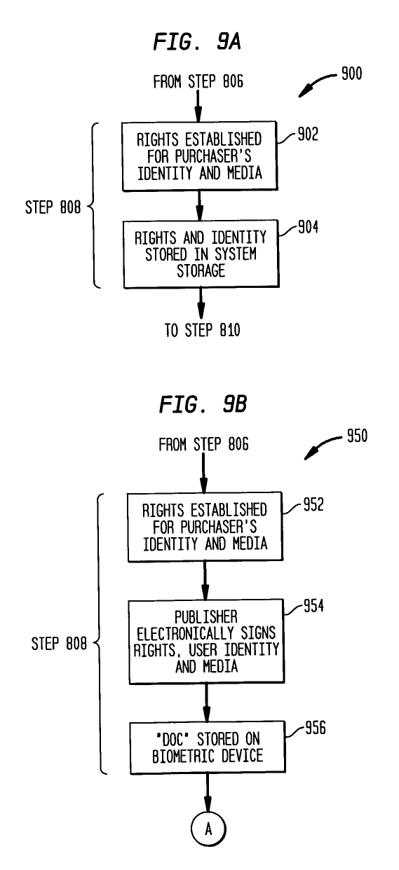

FIG. 9A shows a flow chart depicting a method 900 for performing step 808 according to embodiments of the present invention. Method 900 is performed when subsystem 704 is utilized. At step 902, rights are established for the detected identity of the purchaser and correlated to the purchased media. At step 904, the identity and correlated rights are stored in system storage 712.

FIG. 9B shows a flow chart depicting a method 950 for performing step 808 according to embodiments of the present invention. Method 950 is performed when subsystem 706 is utilized. At step 952, rights are established for the purchaser's identity and correlated to the purchased media. At step 954, a publisher (e.g., third party) electronically signs the rights, user identity, and purchased media, which establishes a “DOC”. At step 956, the “DOC” is stored in a rights storage (e.g., rights storage 702) in biometric device 100. In some embodiments, after method 950 has been performed, the additional steps of checking to see if rights are correct (e.g., step 810) and/or whether additional rights need to be added (e.g., step 812) are not performed. Instead, method 850 is performed. This “DOC” is then sent to the output device via the controller at step 854 to verify identity.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method comprising the steps of:
establishing identity in a media purchasing system using a biometric device to purchase media;
correlating the identity to the purchased media and storing rights relating to said correlation;
receiving the purchased media in a secure output device;
establishing the identity in the secure output device using the wireless transceiver biometric device;
determining if the identity matches said stored rights; and
if the identity matches said stored rights, allowing said output of the purchased media from the secure output device.

2. The method of claim 1, further comprising the step of checking if said stored rights have been properly stored.

3. The method of claim 1, further comprising the steps of:
determining if additional rights need to be added to said stored rights; and
if yes, adding the additional rights to said stored rights.

4. The method of claim 3, further comprising the step of checking if the additional rights have been properly stored.

5. The method of claim 1, wherein said determining step comprises the step of:
transmitting the identity as biometric data to a matching device; and
comparing the identity to a said stored rights in the matching device.

6. The method of claim 1, further comprising the step of storing said stored rights in a storage device coupled to the output device.

7. The method of claim 1, further comprising the step of storing said stored rights in the wireless transceiver biometric device.

8. The method of claim 1, further comprising the step of using said stored rights to allow one-time access to the secure output device.

9. The method of claim 1, further comprising the step of using said stored rights to allow a predetermined number of access times to said secure output device.

10. The method of claim 1, further comprising the step of using said stored rights to allow copying of the purchased media.

11. The method of claim 1, further comprising the step of storing information on how many times the purchased media has been output.

12. The method of claim 11, further comprising the step of using said stored information to determine an obligation.

13. The method of claim 12, further comprising the step of determining an amount of fees owed as said obligation.

14. The method of claim 12, further comprising the step of determining an amount of royalties owed as said obligation.

15. The method of claim 1, comprising the step of using a wireless transceiver biometric device as the biometric device.

16. A system comprising:
media to be purchased;
a purchasing controller coupled to said media; and
a biometric device coupled to said purchasing controller.

17. The system of claim 16, wherein said biometric device is a wireless transceiver biometric device.

18. A system comprising:
a secured output device that outputs purchased media;
a rights checking device coupled to said secured output device; and
a biometric device coupled to said secured output device that sends biometric information to said rights checking device via said secure output device to verify access rights to said secured device to access said copyrighted media.

19. The system of claim 18, wherein said biometric device is a wireless transceiver biometric device.
